(19) United States
(12) Patent Application Publication
(10) Pub. No.: US 2026/0333277 A1
(43) Pub. Date: Oct. 22, 2026

(54) MEASUREMENT GAP DESIGN FOR ATG

(71) Applicant: Apple Inc., Cupertino, CA (US)

(72) Inventors: Yuexia Song, Beijing (CN); Dawei Zhang, Saratoga, CA (US); Qiming Li, Beijing (CN); Yang Tang, San Jose, CA (US); Jie Cui, San Jose, CA (US); Xiang Chen, Campbell, CA (US); Manasa Raghavan, Sunnyvale, CA (US); Rolando E. Bettancourt Ortega, Munich (DE)

(73) Assignee: Apple Inc., Cupertino, CA (US)

(21) Appl. No.: 19/111,294

(22) PCT Filed: Sep. 29, 2022
(86) PCT No.: PCT/CN2022/122876

§ 371 Date: Mar. 12, 2025

(51) Int. Cl. H04W 64/00; H04W 72/231; H04W 74/0816; H04W 88/08

(52) U.S. Cl. CPC H04W 64/00; H04W 72/231; H04W 74/0816; H04W 88/08

(57) ABSTRACT

Provided is a method for a user equipment (UE). The UE performs positioning to obtain location information. The UE obtains location information of a serving base station and location information of at least one neighbor base station from a serving cell. The UE calculates a propagation time difference between (i) propagation time between the UE and the serving cell and (ii) propagation time between the UE and one or more target neighbor cells of the at least one neighbor base station based on the location information of the UE, the location information of the serving base station and the location information of the at least one neighbor base station. The UE determines a measurement gap configuration for the target neighbor cells based on the propagation time difference and a configured measurement gap for the serving cell. And the UE reports the measurement gap configuration to the serving base station.

### TECHNICAL FIELD

This application relates generally to wireless communication systems, and more specifically to measurement gap design for air-to-ground (ATG).

### BACKGROUND

Wireless mobile communication technology uses various standards and protocols to transmit data between a base station and a wireless mobile device. Wireless communication system standards and protocols can include, but not limited to, the 3rd Generation Partnership Project (3GPP) long term evolution (LTE); fifth-generation (5G) 3GPP new radio (NR) standard; and technologies beyond 5G. In fifth-generation (5G) wireless radio access networks (RANs), the base station may include an RAN Node such as a 5G Node, new radio (NR) node or g Node B (gNB), which communicate with a wireless communication device, also known as user equipment (UE).

Recently, many efforts and attentions have been drawn to the ATG work item. An ATG system consists of ATG UEs mounted in an aircraft and ATG base stations on the ground. The ATG system enables an enhancement to the UE mobility through a direct radio link between ATG UEs and ATG base stations. In order to satisfy core and performance requirements of ATG UEs and ATG base stations, the measurement gap design for ATG system needs to be discussed further.

### SUMMARY

According to an aspect of the present disclosure, a method for a user equipment (UE) is provided that comprises performing positioning to obtain location information of the UE, wherein the location information of the UE indicates location, moving speed and moving direction of the UE; obtaining, from a serving cell, location information of a serving base station and location information of at least one neighbor base station; calculating a propagation time difference between (i) propagation time between the UE and the serving cell and (ii) propagation time between the UE and one or more target neighbor cells of the at least one neighbor base station based on the location information of the UE, the location information of the serving base station and the location information of the at least one neighbor base station; determining a measurement gap configuration for the one or more target neighbor cells based on the propagation time difference and a configured measurement gap for the serving cell; and reporting the measurement gap configuration to the serving base station.

According to an aspect of the present disclosure, an apparatus for a user equipment (UE) is provided that comprises one or more processors configured to perform steps of the method according to the present disclosure.

According to an aspect of the present disclosure, a method for a serving base station comprising a serving cell is provided that comprises obtaining, from a user equipment (UE), a UE location report or a system frame number (SFN) and frame timing difference (SFTD) report; and determining a measurement gap configuration for one or more target neighbor cells of at least one neighbor base station based, in part, on the UE location report, or based on the SFTD report.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2A illustrates an exemplary diagram of an ATG system in accordance with some embodiments.

FIG. 2B illustrates an exemplary diagram of a propagation time difference corresponding to FIG. 2A in accordance with some embodiments.

FIG. 3 illustrates a flowchart for an exemplary method for a UE in accordance with some embodiments.

FIG. 4A illustrates an exemplary diagram for an exemplary method for a UE in accordance with some embodiments.

FIG. 4B illustrates an exemplary diagram for an exemplary method for a UE in accordance with some other embodiments.

FIG. 5 illustrates a flowchart for an exemplary method for a serving base station in accordance with some embodiments.

FIG. 6A illustrates an exemplary diagram for an exemplary method for a serving base station in accordance with some embodiments.

FIG. 6B illustrates an exemplary diagram for an exemplary method for a serving base station in accordance with some other embodiments.

FIG. 7 illustrates an exemplary block diagram of an apparatus for a UE in accordance with some embodiments.

FIG. 8 illustrates an exemplary block diagram of an apparatus for a serving base station comprising a serving cell in accordance with some embodiments.

FIG. 9 illustrates example components of a device in accordance with some embodiments.

FIG. 10 illustrates example interfaces of baseband circuitry in accordance with some embodiments.

FIG. 11 illustrates components in accordance with some embodiments.

FIG. 12 illustrates an architecture of a wireless network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

In the technologies related to the ATG system, new requirements for ATG base station and ATG UE are still being discussed due to the particularity of ATG network deployment.

An ATG system consists of ATG UEs mounted in an aircraft and ATG base stations on the ground. The ATG base stations comprises a serving base station and some neighbor base stations. During the flight of the aircraft, the UE performs an inter-frequency measurement to achieve a cell handover between a serving cell of serving base station and a target neighbor cell of a neighbor base stations.

Compared with an existing terrestrial network (TN) system, in which measurement gap length (MGL) for inter-frequency measurement is selected from a group consisting of: 1.5 ms, 3 ms, 3.5 ms, 4 ms, 5.5 ms, and 6 ms, the measurement gap configuration for an ATG system need to be further improved. Because the base stations in an ATG system are configured with extreme large cell coverage range (e.g., up to 300 kilometers), which causes the propagation time between the UE and a serving cell of the serving base station may be different from the propagation time between the UE and the target neighbor cell. As a result, the legacy measurement gap design for a TN system may not cover the target SSB burst from a target neighbor cells.

Aiming to this, it is provided by the present disclosure new measurement gap design for ATG. Various aspects of the present disclosure will be described below in conjunction with the accompanying drawings.

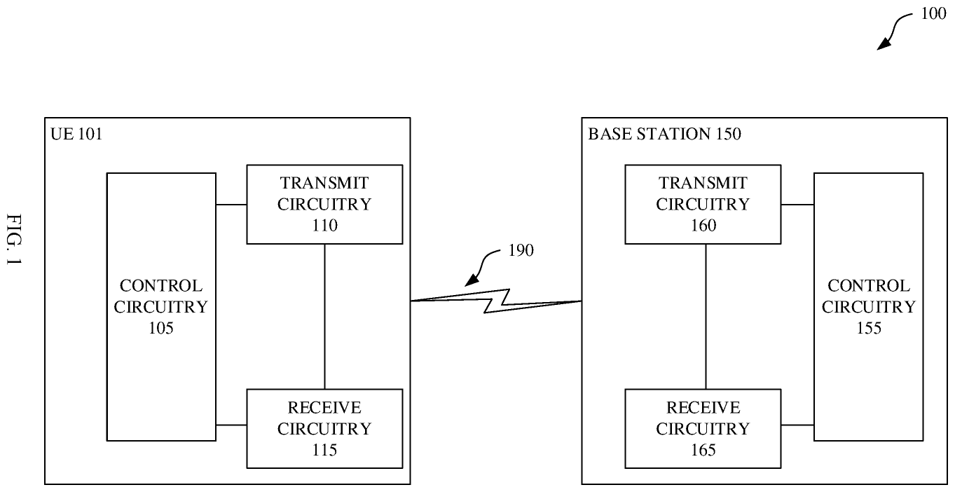

FIG. 1 is a block diagram of a system including a base station and a UE in accordance with some embodiments. FIG. 1 illustrates a wireless network 100, in accordance with some embodiments. The wireless network 100 includes a UE 101 and a base station 150 connected via an air interface 190. In some embodiments, the UE 101 may be an ATG UE. In some embodiments, the base station 150 may be an ATG base station, such a serving ATG base station or a neighbor ATG base station.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120-degree area with an array of antennas directed to each sector to provide 360-degree coverage around the base station 150.

The UE 101 includes control circuitry 105 coupled with transmit circuitry 110 and receive circuitry 115. The transmit circuitry 110 and receive circuitry 115 may each be coupled with one or more antennas. The control circuitry 105 may be adapted to perform operations associated with Machine Type Communication (MTC). In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TDM) or frequency division multiplexing (FDM). The transmit circuity 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g., messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The control circuitry 155 may be adapted to perform operations associated with MTC. The transmit circuitry 160 and receive circuitry 165 may be adapted to transmit and receive data, respectively, within a narrow system bandwidth that is narrower than a standard bandwidth structured for person-to-person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is included of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is included of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the UE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

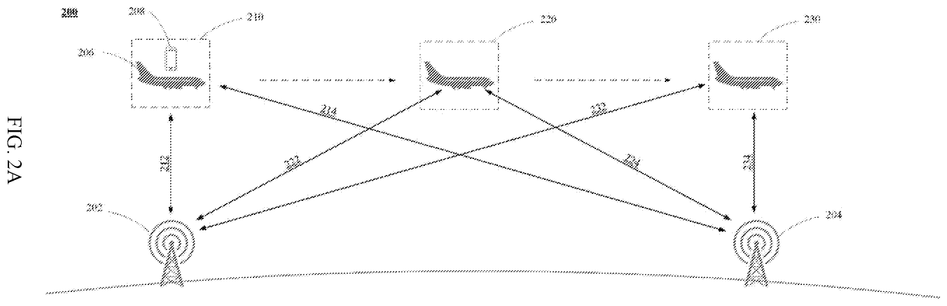

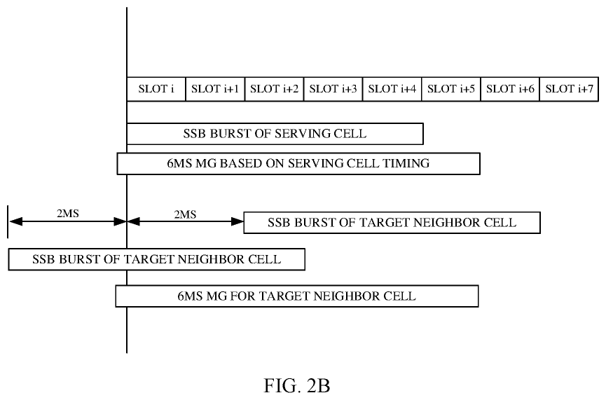

FIG. 2A illustrates an exemplary diagram of an ATG system 200 in accordance with some embodiments.

As shown in FIG. 2A, the ATG system consists of an ATG UE 208 mounted in an aircraft 206 and ATG base stations 202, 204, which are deployed on the ground. In some embodiments, the ATG base station 202 is a serving ATG base station which is communicating with the ATG UE 208, and the ATG base station 204 is a neighbor ATG base station. Note that although not illustrated in FIG. 2A, there may be more than one neighbor ATG base station in the ATG system. And each neighbor ATG base station may provide one or more neighbor cells to perform a cell handover. In some embodiments, each of the ATG base stations 202 and 204 has a cell coverage range of 300 kilometers (km). That is, the distance between the ATG base station 202 and ATG base station 204 reaches 600 km. In FIG. 2A, three positions of the aircraft 206 on the flight path between the ATG base station 202 and ATG base station 204 are also illustrated. In the example, position 220 is right in the middle of the two ATG base station 202 and ATG base station 204. When the aircraft 206 arrives at position 220, the propagation time 222 between the ATG UE 208 and the serving cell of the ATG base station 202 equals to the propagation time 224 between the ATG UE 208 and a target neighbor cell of the ATG base station 204. Therefore, there would not be a propagation time difference. In the example, position 210 is right over the ATG base station 202 and position 230 is right over the ATG base station 204. When the aircraft 206 arrives at position 210 or 230, a propagation time difference may occur and cause a failure of measurement of a target neighbor cell. The propagation time difference and its impact on measurement of a target neighbor cell will be described below in conjunction with FIG. 2B.

FIG. 2B illustrates an exemplary diagram of a propagation time difference corresponding to FIG. 2A in accordance with some embodiments.

As shown in FIG. 2B, based on serving cell timing, a 6-milliseconds (ms) measurement gap is configured to cover different synchronization signal block (SSB) number in the SSB burst of the serving cell (e.g., 8 SSB in 4 slots).

Referring back to FIG. 2A, when the aircraft 206 arrives at position 210, there may be a propagation time difference between (i) propagation time 212 between the ATG UE 208 and the serving cell of the ATG base station 202 and (ii) propagation time 214 between the ATG UE 208 and a target neighbor cell of the ATG base station 204. In some embodiments where the distance between the ATG base station 202 and ATG base station 204 reaches 600 km, the propagation time difference may be approximately calculated as 2 ms, i.e., the distance between the ATG base station 202 and ATG base station 204 divided by the speed of light. As can be seen in FIG. 2B, due to this propagation time difference (+2 ms), the SSB burst of a target neighbor cell (e.g., 8 SSB in 4 slots) is 2 ms delayed relative to the SSB burst of serving cell. Therefore, if the MG configuration for the target neighbor cell remains the same as the MG configuration for the serving cell, the latter part of the SSB burst of a target neighbor cell may be missing.

Referring back to FIG. 2A again, when the aircraft 206 arrives at position 230, there may be a propagation time difference between (i) propagation time 232 between the ATG UE 208 and the serving cell of the ATG base station 202 and (ii) propagation time 234 between the ATG UE 208 and a target neighbor cell of the ATG base station 204. In some embodiments where the distance between the ATG base station 202 and ATG base station 204 reaches 600 km, the propagation time difference may be approximately calculated as 2 ms, i.e., the distance between the ATG base station 202 and ATG base station 204 divided by the speed of light. As can be seen in FIG. 2B, due to this propagation time difference (−2 ms), the SSB burst of a target neighbor cell (e.g., 8 SSB in a slots) is 2 ms ahead of the SSB burst of serving cell. Therefore, if the MG configuration for the target neighbor cell remains the same as the MG configuration for the serving cell, the front part of the SSB burst of a target neighbor cell may be missing.

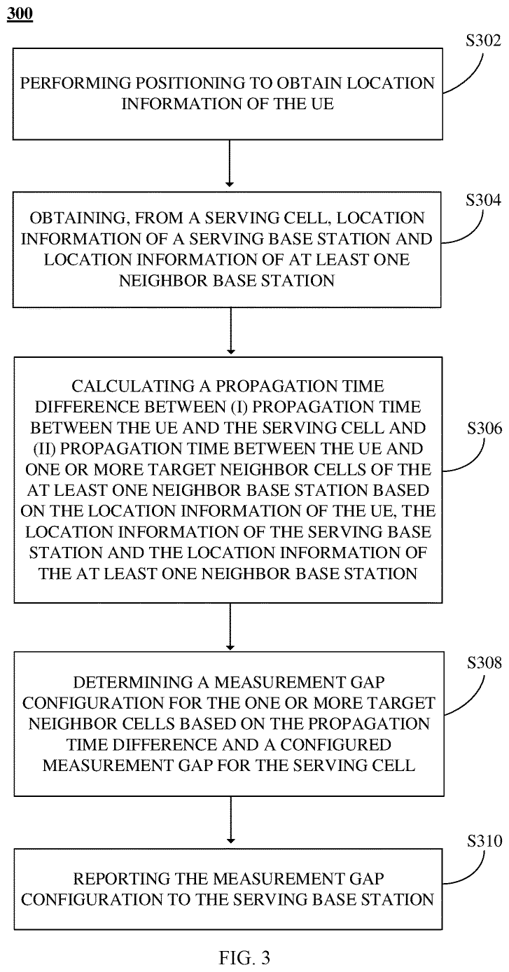

FIG. 3 illustrates a flowchart for an exemplary method for a UE in accordance with some embodiments. In some embodiment, the method 300 illustrated in FIG. 3 may be implemented by the UE 101 described in FIG. 1. For example, the UE 101 may be an ATG UE.

In some embodiments, the method 300 for UE may include the following steps: S302, performing positioning to obtain location information of the UE; S304, obtaining, from a serving cell, location information of a serving base station and location information of at least one neighbor base station; S306, calculating a propagation time difference between (i) propagation time between the UE and the serving cell and (ii) propagation time between the UE and one or more target neighbor cells of the at least one neighbor base station based on the location information of the UE, the location information of the serving base station and the location information of the at least one neighbor base station; S308, determining a measurement gap configuration for the one or more target neighbor cells based on the propagation time difference and a configured measurement gap for the serving cell; and S310, reporting the measurement gap configuration to the serving base station.

According to the method of some embodiments of the present disclosure, by determining, at UE side, a measurement gap configuration for the one or more target neighbor cells based on the propagation time difference and a configured measurement gap for the serving cell, the target SSB burst from the one or more target neighbor cells may be fully covered by the measurement gap for the one or more target neighbor cells.

In the following, each step of the method 300 will be described in detail.

At step S302, the UE performs positioning to obtain location information of the UE. The location information of the UE may indicate a location of, or a location, moving speed and moving direction of the UE.

In some embodiments, the UE may be configured to support Global Navigation Satellite System (GNSS) capability. With GNSS capability, the UE may determine its own location, moving speed and moving direction in real time.

At step S304, the UE obtains location information of a serving base station and location information of at least one neighbor base station from a serving cell. The location information of the serving base station may indicate the location of the serving base station. The location information of the at least one neighbor base station may indicate the location of the at least one neighbor base station.

In some embodiments, the location information of the at least one neighbor base station may be indicated by the serving cell using dedicated signaling (e.g., RRC signaling).

At step S306, the UE calculates a propagation time difference between (i) propagation time between the UE and the serving cell and (ii) propagation time between the UE and one or more target neighbor cells of the at least one neighbor base station based on the location information of the UE, the location information of the serving base station and the location information of the at least one neighbor base station.

An example method for calculating the propagation time difference will be described below with reference back to FIG. 2A.

In FIG. 2A, the vertical distance between the aircraft 206 and the ATG base stations 202, 204 is much less than the distance between the ATG base station 202 and ATG base station 204. Therefore, the vertical distance can be ignored when calculating the propagation time difference and only the horizontal distance is considered. The propagation time difference may be calculated as follows: the horizontal distance between the ATG UE 208 and the ATG base station 204 minus the horizontal distance between the ATG UE 208 and the ATG base station 202, and then divided by the speed of light. Taking the aircraft 206 at position 210 as an example, the propagation time difference may be calculated as 600 km/c=2 ms, where c represents the speed of light. This the propagation time difference of 2 ms indicates that the SSB burst of a target neighbor cell is 2 ms delayed relative to the SSB burst of serving cell.

In some embodiments, the one or more target neighbor cells may be included in a neighbor cell list provided by the serving cell. The neighbor cell list may include a plurality of neighbor cells of a neighbor base station or a plurality of neighbor cells of different neighbor base stations. And the UE in the coverage of the serving cell may receive the neighbor cell list via the broadcasting of the serving cell.

In some embodiments, the at least one neighbor base station and the serving base station may be ATG base stations and the UE is an ATG UE.

Back to FIG. 3, at step S308, the UE determines a measurement gap configuration for the one or more target neighbor cells based on the propagation time difference and a configured measurement gap for the serving cell.

In some embodiments, the measurement gap configuration may comprise an offset applied to the configured measurement gap relative to a timing of the serving cell, wherein the offset is not greater than an offset threshold.

In some embodiments, the offset threshold may be equal to the propagation time difference.

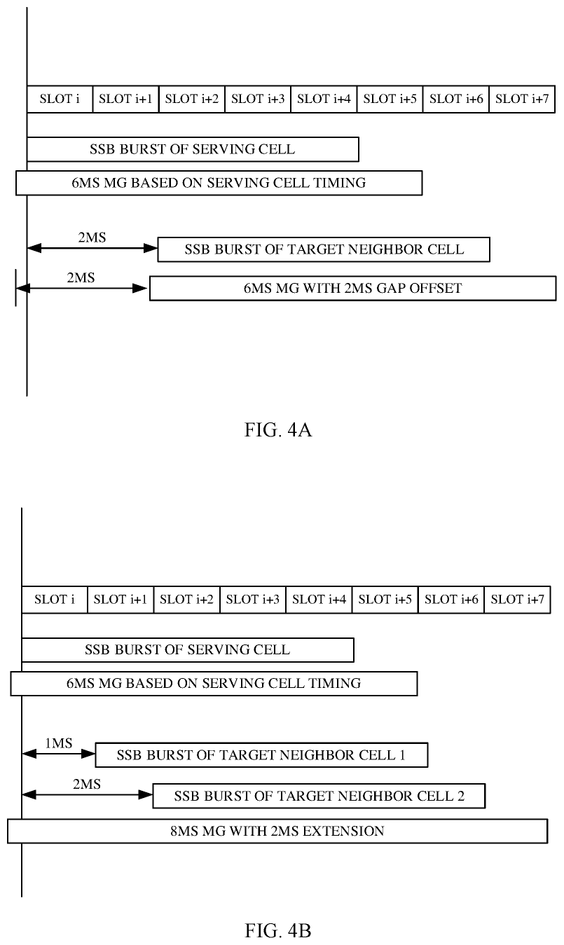

FIG. 4A illustrates an exemplary diagram for an exemplary method for a UE in accordance with some embodiments.

Referring to FIGS. 4A and 2A, taking position 210 as an example, due to the propagation time difference of 2 ms, the SSB burst of a target neighbor cell is 2 ms delayed relative to the SSB burst of serving cell. In order to cover the SSB burst of the target neighbor cell, the UE may determine to offset the measurement gap for the target neighbor cell relative to the timing of the serving cell. As can be seen in FIG. 4A, the offset may be not greater than an offset threshold, which may be equal to the propagation time difference of 2 ms. In the meanwhile, the length of the measurement gap for the target neighbor cell may stay the same as the length of the measurement gap for the serving cell.

In some embodiments, the offset may be selected from a group consisting of −2 ms, −1.5 ms, −1 ms, −0.5 ms, 0 ms, 0.5 ms, 1 ms, 1.5 ms, and 2 ms. Back to FIG. 4A, in some embodiments, when the aircraft 206 arrives at a position between position 210 and position 220, in response to a propagation time difference between 0 to 2 ms, the offset may be selected from one of 0 ms, 0.5 ms, 1 ms, 1.5 ms, and 2 ms. In some embodiments, when the aircraft 206 arrives at a position between position 220 and position 230, in response to a propagation time difference between −2 to 0 ms, the offset may be selected from one of −2 ms, −1.5 ms, −1 ms, −0.5 ms, and 0 ms. In an example, in response to a propagation time difference of 1.8 ms, an offset of 1.5 ms may be applied. In another example, in response to a propagation time difference of −1.8 ms, an offset of −2 ms may be applied.

In some embodiments, the measurement gap configuration may comprise an extension applied to the configured measurement gap relative to a timing of the serving cell, wherein the extension is not greater than an extension threshold.

In some embodiments, the extension threshold may be equal to the propagation time difference.

FIG. 4B illustrates an exemplary diagram for an exemplary method for a UE in accordance with some other embodiments. The detailed setting of the extension is shown in FIG. 4B.

Referring to FIGS. 4B and 2A, taking position 210 as an example, due to the propagation time difference of 2 ms, the SSB burst of a target neighbor cell is 2 ms delayed relative to the SSB burst of serving cell. In order to cover the SSB burst of the target neighbor cell, the UE may determine to extend the length of the measurement gap for the target neighbor cell relative to the timing of the serving cell. As can be seen in FIG. 4B, the extension may be not greater than an extension threshold, which may be equal to the propagation time difference of 2 ms. In the meanwhile, the UE may not offset the measurement gap for the target neighbor cell relative to the timing of the serving cell. With the extension to the measurement gap, the UE may be capable to measure a plurality of neighbor cell on inter-frequency. The plurality of neighbor cell on inter-frequency may include a plurality of neighbor cells of the same neighbor base station or a plurality of neighbor cells of different neighbor base stations.

In some embodiments, the extension may be selected from a group consisting of 0 ms, 0.5 ms, 1 ms, 1.5 ms, and 2 ms. Back to FIG. 4B, in some embodiments, when the aircraft 206 arrives at a position between position 210 and position 220, in response to a propagation time difference between 0 to 2 ms, the extension may be selected from one of 0 ms, 0.5 ms, 1 ms, 1.5 ms, and 2 ms. In an example, in response to a propagation time difference of 1.8 ms, an extension of 1.5 ms may be applied. In another example, in response to a propagation time difference of 1.3 ms, an extension of 1 ms may be applied.

At Step S310, the UE reports the measurement gap configuration to the serving base station.

In some embodiments, the determining and reporting of the measurement gap configuration in step S308 and step S310 may be periodic or event triggered. In some embodiments, the event may include at least one of: a measurement trigger for events A1 to A6 satisfies a measurement trigger threshold; a hysteresis for events A1 to A6 satisfies a hysteresis threshold; and a timer to trigger for events A1 to A6 satisfies a timing threshold.

In some embodiments, an apparatus for a user equipment (UE) may include one or more processors configured to perform any of steps of the above methods according to the present disclosure.

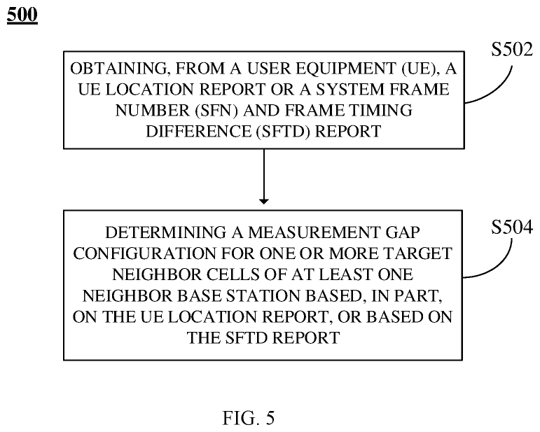

FIG. 5 illustrates a flowchart for an exemplary method for a serving base station in accordance with some embodiments. The method 500 illustrated in FIG. 5 may be implemented by the base station 150 described in FIG. 1. For example, the base station 150 may be a serving ATG base station.

In some embodiments, the method 500 for a serving base station may include the following steps: S502, obtaining, from a user equipment (UE), a UE location report or a system frame number (SFN) and frame timing difference (SFTD) report; and S504, determining a measurement gap configuration for one or more target neighbor cells of at least one neighbor base station based, in part, on the UE location report, or based on the SFTD report.

According to the method of some embodiments of the present disclosure, by determining, at base station side, a measurement gap configuration for one or more target neighbor cells of at least one neighbor base station based, in part, on the UE location report, or based on the SFTD report, the target SSB burst from the one or more target neighbor cells may be fully covered by the measurement gap for the one or more target neighbor cells.

In the following, each step of the method 300 will be described in detail.

At step S502, the serving base station obtains a UE location report or a system frame number (SFN) and frame timing difference (SFTD) report from a user equipment (UE).

In some embodiments, the method 300 may further comprise obtaining location information of the at least one neighbor base station from the at least one neighbor base station or from a location server. The UE location report comprises a location of, or a location, moving speed and moving direction of the UE. The measurement gap configuration is determined based on the location, moving speed and moving direction of the UE, location information of the serving base station, and the location information of the at least one neighbor base station.

At step S504, the serving base station determines a measurement gap configuration for one or more target neighbor cells of at least one neighbor base station based, in part, on the UE location report, or based on the SFTD report.

In some embodiments, the serving station may determine the measurement gap configuration based on the location of the UE, the location of the neighbor base station and the serving base station's own location.

In some embodiments, the serving station may determine the measurement gap configuration based on the SFTD report provided by the UE.

In some embodiments, the SFTD report comprises measurements of SFTD between the serving cell and the one or more target neighbor cells.

In some embodiments, the measurement gap configuration may comprise an offset applied to a configured measurement gap relative to a timing of the serving cell, wherein the offset is not greater than an offset threshold.

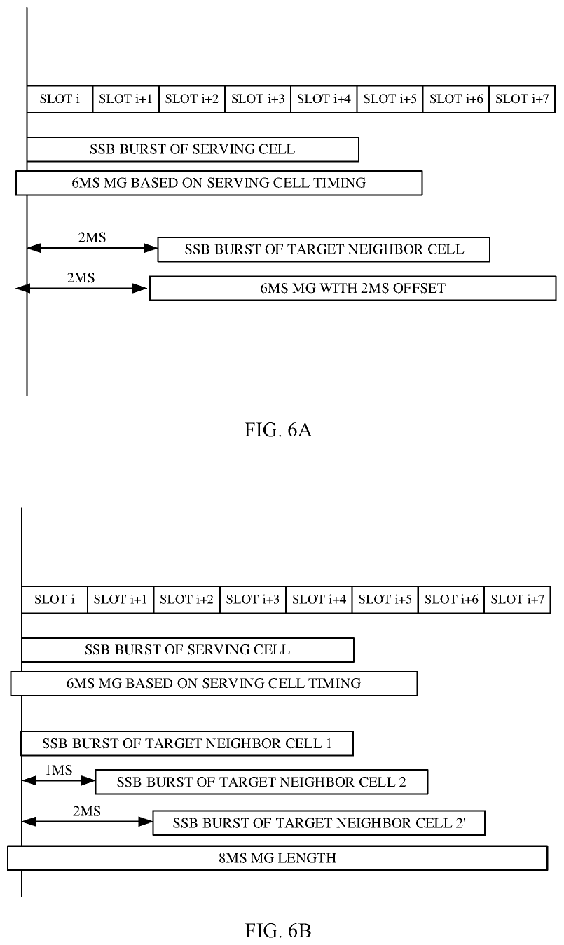

FIG. 6A illustrates an exemplary diagram for an exemplary method for a serving base station in accordance with some embodiments.

As can be seen in FIG. 6A, due to the propagation time difference of 2 ms, the SSB burst of a target neighbor cell is 2 ms delayed relative to the SSB burst of serving cell. To fully cover the SSB burst of the target neighbor cell, the serving base station may determine to offset the measurement gap for the target neighbor cell relative to the timing of the serving cell. The offset may be not greater than an offset threshold (e.g. the propagation time difference). In FIG. 6A, in response to a propagation time difference of 2 ms, the offset may be configured as 2 ms.

In some embodiments, the offset may be selected from a group consisting of: −2 ms, −1.5 ms, −1 ms, −0.5 ms, 0 ms, 0.5 ms, 1 ms, 1.5 ms, and 2 ms. In some embodiments, in response to a propagation time difference between 0 to 2 ms, the offset may be selected from one of 0 ms, 0.5 ms, 1 ms, 1.5 ms, and 2 ms. In an example, in response to a propagation time difference of 1.3 ms, an offset of 1 ms may be applied. In some embodiments, in response to a propagation time difference between −2 to 0 ms, the offset may be selected from one of −2 ms, −1.5 ms, −1 ms, −0.5 ms, and 0 ms. In an example, in response to a propagation time difference of −1.3 ms, an offset of −1.5 ms may be applied. In the meanwhile, the length of the measurement gap for the target neighbor cell may stay the same as the length of the measurement gap for the serving cell.

In some embodiments, the measurement gap configuration may comprise an extended measurement gap length relative to a timing of the serving cell.

FIG. 6B illustrates an exemplary diagram for an exemplary method for a serving base station in accordance with some other embodiments.

As can be seen in FIG. 6B, due to the propagation time difference of 2 ms, the SSB burst of a target neighbor cell is 2 ms delayed relative to the SSB burst of serving cell. To fully cover the SSB burst of the target neighbor cell, the serving base station may determine to apply an extended measurement gap length for the target neighbor cell relative to a timing of the serving cell. The extended measurement gap length is equal to a length of a configured measurement gap for the serving cell plus the propagation time difference. Referring to FIG. 6B, the length of the configured measurement gap is 6 ms, in response to a propagation time difference of 2 ms, an extended measurement gap length of 8 ms may be applied. In the meanwhile, the serving base station may not offset the measurement gap for the target neighbor cell relative to the timing of the serving cell. With the extension to the measurement gap, the UE may be capable to measure a plurality of neighbor cell on inter-frequency. The plurality of neighbor cells on inter-frequency may include a plurality of neighbor cells of the same neighbor base station or a plurality of neighbor cells of different neighbor base stations.

In some embodiments, the extended measurement gap length may be selected from a group consisting of: 1.5 ms, 3 ms, 3.5 ms, 4 ms, 5.5 ms, 6 ms, 6.5 ms, 7.0 ms, 7.5 ms, and 8 ms.

In some embodiments, the method 500 may further include: configuring the measurement gap configuration to the UE via one of: radio resource control (RRC) signaling, medium access control (MAC) control element (CE) and downlink control information (DCI).

In some embodiments, the at least one neighbor base station and the serving base station may be ATG base stations and the UE is an ATG UE.

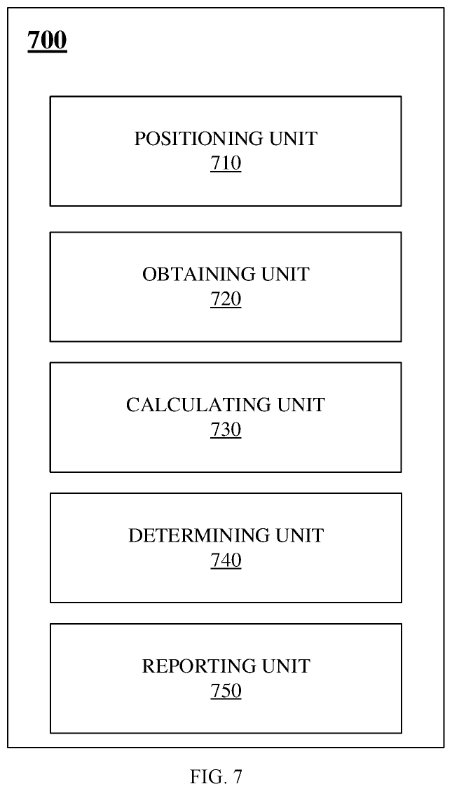

FIG. 7 illustrates an exemplary block diagram of an apparatus for a UE in accordance with some embodiments. The apparatus 700 illustrated in FIG. 7 may be used to implement the method 300 as illustrated in combination with FIG. 3.

As illustrated in FIG. 7, the apparatus 700 includes a positioning unit 710, an obtaining unit 720, a calculating unit 730, a determining unit 740 and a reporting unit 750.

The positioning unit 710 is configured to perform positioning to obtain location information of the UE, wherein the location information of the UE indicates location, moving speed and moving direction of the UE.

The obtaining unit 720 is configured to obtain location information of a serving base station and location information of at least one neighbor base station from a serving cell.

The calculating unit 730 is configured to calculate a propagation time difference between (i) propagation time between the UE and the serving cell and (ii) propagation time between the UE and one or more target neighbor cells of the at least one neighbor base station based on the location information of the UE, the location information of the serving base station and the location information of the at least one neighbor base station.

The determining unit 740 is configured to determine a measurement gap configuration for the one or more target neighbor cells based on the propagation time difference and a configured measurement gap for the serving cell.

The reporting unit 750 is configured to report the measurement gap configuration to the serving base station.

According to the apparatus of some embodiments of the present disclosure, by determining, at UE side, a measurement gap configuration for the one or more target neighbor cells based on the propagation time difference and a configured measurement gap for the serving cell, the target SSB burst from the one or more target neighbor cells may be fully covered by the measurement gap for the one or more target neighbor cells.

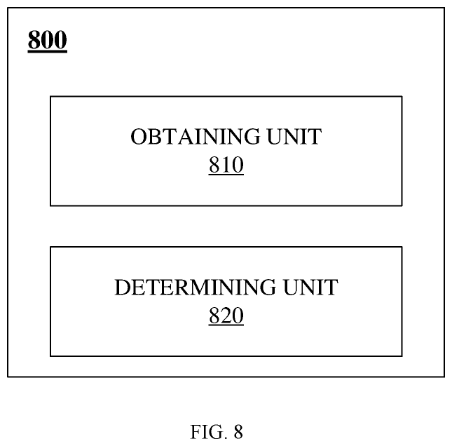

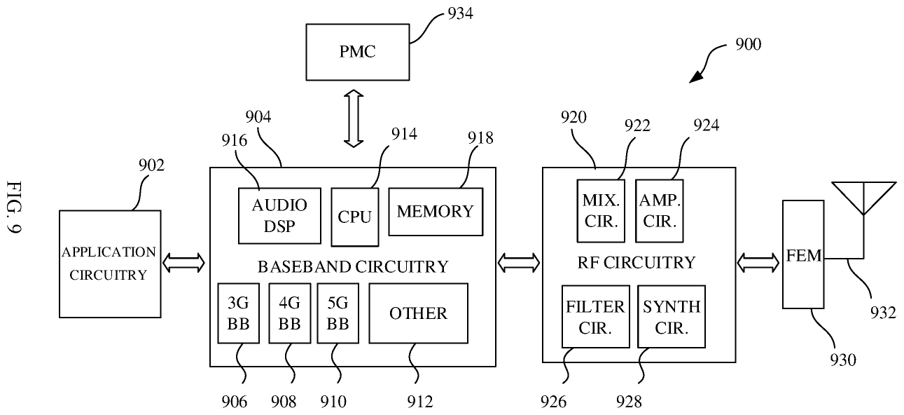

FIG. 8 illustrates an exemplary block diagram of an apparatus for a serving base station comprising a serving cell in accordance with some embodiments. The apparatus 800 illustrated in FIG. 8 may be used to implement the method 500 as illustrated in combination with FIG. 5.

As illustrated in FIG. 8, the apparatus 800 includes an obtaining unit 810 and a determining unit 820.

The obtaining unit 810 is configured to obtain a UE location report or a system frame number (SFN) and frame timing difference (SFTD) report from a user equipment (UE).

The determining unit 820 is configured to determine a measurement gap configuration for one or more target neighbor cells of at least one neighbor base station based, in part, on the UE location report, or based on the SFTD report.

According to the apparatus of some embodiments of the present disclosure, by determining, at base station side, a measurement gap configuration for one or more target neighbor cells of at least one neighbor base station based, in part, on the UE location report, or based on the SFTD report, the target SSB burst from the one or more target neighbor cells may be fully covered by the measurement gap for the one or more target neighbor cells.

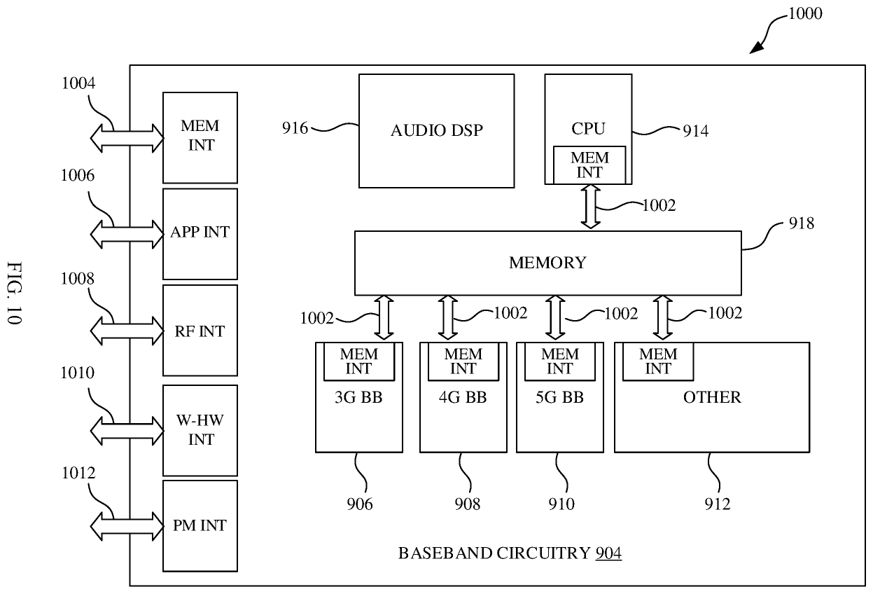

FIG. 9 illustrates example components of a device 900 in accordance with some embodiments. In some embodiments, the device 900 may include application circuitry 902, baseband circuitry 904, Radio Frequency (RF) circuitry (shown as RF circuitry 920), front-end module (FEM) circuitry (shown as FEM circuitry 930), one or more antennas 932, and power management circuitry (PMC) (shown as PMC 934) coupled together at least as shown. The components of the illustrated device 900 may be included in a UE or a RAN node. In some embodiments, the device 900 may include fewer elements (e.g., a RAN node may not utilize application circuitry 902, and instead include a processor/controller to process IP data received from an EPC). In some embodiments, the device 900 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 902 may include one or more application processors. For example, the application circuitry 902 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 900. In some embodiments, processors of application circuitry 902 may process IP data packets received from an EPC.

The baseband circuitry 904 may include circuitry such as, but not limited to, one or more single-core or multi-core processors. The baseband circuitry 904 may include one or more baseband processors or control logic to process baseband signals received from a receive signal path of the RF circuitry 920 and to generate baseband signals for a transmit signal path of the RF circuitry 920. The baseband circuitry 904 may interface with the application circuitry 902 for generation and processing of the baseband signals and for controlling operations of the RF circuitry 920. For example, in some embodiments, the baseband circuitry 904 may include a third generation (3G) baseband processor (3G baseband processor 906), a fourth generation (4G) baseband processor (4G baseband processor 908), a fifth generation (5G) baseband processor (5G baseband processor 910), or other baseband processor(s) 912 for other existing generations, generations in development or to be developed in the future (e.g., second generation (2G), sixth generation (6G), etc.). The baseband circuitry 904 (e.g., one or more of baseband processors) may handle various radio control functions that enable communication with one or more radio networks via the RF circuitry 920. In other embodiments, some or all of the functionality of the illustrated baseband processors may be included in modules stored in the memory 918 and executed via a Central Processing Unit (CPU 914). The radio control functions may include, but are not limited to, signal modulation/demodulation, encoding/decoding, radio frequency shifting, etc. In some embodiments, modulation/demodulation circuitry of the baseband circuitry 904 may include Fast-Fourier Transform (FFT), precoding, or constellation mapping/demapping functionality. In some embodiments, encoding/decoding circuitry of the baseband circuitry 904 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 904 may include a digital signal processor (DSP), such as one or more audio DSP(s) 916. The one or more audio DSP(s) 916 may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 904 and the application circuitry 902 may be implemented together such as, for example, on a system on a chip (SOC).

In some embodiments, the baseband circuitry 904 may provide for communication compatible with one or more radio technologies. For example, in some embodiments, the baseband circuitry 904 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 904 is configured to support radio communications of more than one wireless protocol may be referred to as multi-mode baseband circuitry.

The RF circuitry 920 may enable communication with wireless networks using modulated electromagnetic radiation through a non-solid medium. In various embodiments, the RF circuitry 920 may include switches, filters, amplifiers, etc. to facilitate the communication with the wireless network. The RF circuitry 920 may include a receive signal path which may include circuitry to down-convert RF signals received from the FEM circuitry 930 and provide baseband signals to the baseband circuitry 904. The RF circuitry 920 may also include a transmit signal path which may include circuitry to up-convert baseband signals provided by the baseband circuitry 904 and provide RF output signals to the FEM circuitry 930 for transmission.

In some embodiments, the receive signal path of the RF circuitry 920 may include mixer circuitry 922, amplifier circuitry 924 and filter circuitry 926. In some embodiments, the transmit signal path of the RF circuitry 920 may include filter circuitry 926 and mixer circuitry 922. The RF circuitry 920 may also include synthesizer circuitry 928 for synthesizing a frequency for use by the mixer circuitry 922 of the receive signal path and the transmit signal path. In some embodiments, the mixer circuitry 922 of the receive signal path may be configured to down-convert RF signals received from the FEM circuitry 930 based on the synthesized frequency provided by synthesizer circuitry 928. The amplifier circuitry 924 may be configured to amplify the down-converted signals and the filter circuitry 926 may be a low-pass filter (LPF) or band-pass filter (BPF) configured to remove unwanted signals from the down-converted signals to generate output baseband signals. Output baseband signals may be provided to the baseband circuitry 904 for further processing. In some embodiments, the output baseband signals may be zero-frequency baseband signals, although this is not a requirement. In some embodiments, the mixer circuitry 922 of the receive signal path may include passive mixers, although the scope of the embodiments is not limited in this respect.

In some embodiments, the mixer circuitry 922 of the transmit signal path may be configured to up-convert input baseband signals based on the synthesized frequency provided by the synthesizer circuitry 928 to generate RF output signals for the FEM circuitry 930. The baseband signals may be provided by the baseband circuitry 904 and may be filtered by the filter circuitry 926.

In some embodiments, the mixer circuitry 922 of the receive signal path and the mixer circuitry 922 of the transmit signal path may include two or more mixers and may be arranged for quadrature downconversion and upconversion, respectively. In some embodiments, the mixer circuitry 922 of the receive signal path and the mixer circuitry 922 of the transmit signal path may include two or more mixers and may be arranged for image rejection (e.g., Hartley image rejection). In some embodiments, the mixer circuitry 922 of the receive signal path and the mixer circuitry 922 may be arranged for direct downconversion and direct upconversion, respectively. In some embodiments, the mixer circuitry 922 of the receive signal path and the mixer circuitry 922 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 920 may include analog-to-digital converter (ADC) and digital-to-analog converter (DAC) circuitry and the baseband circuitry 904 may include a digital baseband interface to communicate with the RF circuitry 920. In some dual-mode embodiments, a separate radio IC circuitry may be provided for processing signals for each spectrum, although the scope of the embodiments is not limited in this respect.

In some embodiments, the synthesizer circuitry 928 may be a fractional-N synthesizer or a fractional N/N+1 synthesizer, although the scope of the embodiments is not limited in this respect as other types of frequency synthesizers may be suitable. For example, synthesizer circuitry 928 may be a delta-sigma synthesizer, a frequency multiplier, or a synthesizer including a phase-locked loop with a frequency divider.

The synthesizer circuitry 928 may be configured to synthesize an output frequency for use by the mixer circuitry 922 of the RF circuitry 920 based on a frequency input and a divider control input. In some embodiments, the synthesizer circuitry 928 may be a fractional N/N+1 synthesizer. In some embodiments, frequency input may be provided by a voltage controlled oscillator (VCO), although that is not a requirement. Divider control input may be provided by either the baseband circuitry 904 or the application circuitry 902 (such as an applications processor) depending on the desired output frequency. In some embodiments, a divider control input (e.g., N) may be determined from a look-up table based on a channel indicated by the application circuitry 902.

Synthesizer circuitry 928 of the RF circuitry 920 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 928 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 920 may include an IQ/polar converter.

The FEM circuitry 930 may include a receive signal path which may include circuitry configured to operate on RF signals received from one or more antennas 932, amplify the received signals and provide the amplified versions of the received signals to the RF circuitry 920 for further processing. The FEM circuitry 930 may also include a transmit signal path which may include circuitry configured to amplify signals for transmission provided by the RF circuitry 920 for transmission by one or more of the one or more antennas 932. In various embodiments, the amplification through the transmit or receive signal paths may be done solely in the RF circuitry 920, solely in the FEM circuitry 930, or in both the RF circuitry 920 and the FEM circuitry 930.

In some embodiments, the FEM circuitry 930 may include a TX/RX switch to switch between transmit mode and receive mode operation. The FEM circuitry 930 may include a receive signal path and a transmit signal path. The receive signal path of the FEM circuitry 930 may include an LNA to amplify received RF signals and provide the amplified received RF signals as an output (e.g., to the RF circuitry 920). The transmit signal path of the FEM circuitry 930 may include a power amplifier (PA) to amplify input RF signals (e.g., provided by the RF circuitry 920), and one or more filters to generate RF signals for subsequent transmission (e.g., by one or more of the one or more antennas 932).

In some embodiments, the PMC 934 may manage power provided to the baseband circuitry 904. In particular, the PMC 934 may control power-source selection, voltage scaling, battery charging, or DC-to-DC conversion. The PMC 934 may often be included when the device 900 is capable of being powered by a battery, for example, when the device 900 is included in an UE. The PMC 934 may increase the power conversion efficiency while providing desirable implementation size and heat dissipation characteristics.

FIG. 9 shows the PMC 934 coupled only with the baseband circuitry 904. However, in other embodiments, the PMC 934 may be additionally or alternatively coupled with, and perform similar power management operations for, other components such as, but not limited to, the application circuitry 902, the RF circuitry 920, or the FEM circuitry 930.

In some embodiments, the PMC 934 may control, or otherwise be part of, various power saving mechanisms of the device 900. For example, if the device 900 is in an RRC Connected state, where it is still connected to the RAN node as it expects to receive traffic shortly, then it may enter a state known as Discontinuous Reception Mode (DRX) after a period of inactivity. During this state, the device 900 may power down for brief intervals of time and thus save power.

If there is no data traffic activity for an extended period of time, then the device 900 may transition off to an RRC Idle state, where it disconnects from the network and does not perform operations such as channel quality feedback, handover, etc. The device 900 goes into a very low power state and it performs paging where again it periodically wakes up to listen to the network and then powers down again. The device 900 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 902 and processors of the baseband circuitry 904 may be used to execute elements of one or more instances of a protocol stack. For example, processors of the baseband circuitry 904, alone or in combination, may be used to execute Layer 3, Layer 2, or Layer 1 functionality, while processors of the application circuitry 902 may utilize data (e.g., packet data) received from these layers and further execute Layer 4 functionality (e.g., transmission communication protocol (TCP) and user datagram protocol (UDP) layers). As referred to herein, Layer 3 may include a radio resource control (RRC) layer, described in further detail below. As referred to herein, Layer 2 may include a medium access control (MAC) layer, a radio link control (RLC) layer, and a packet data convergence protocol (PDCP) layer, described in further detail below. As referred to herein, Layer 1 may include a physical (PHY) layer of a UE/RAN node, described in further detail below.

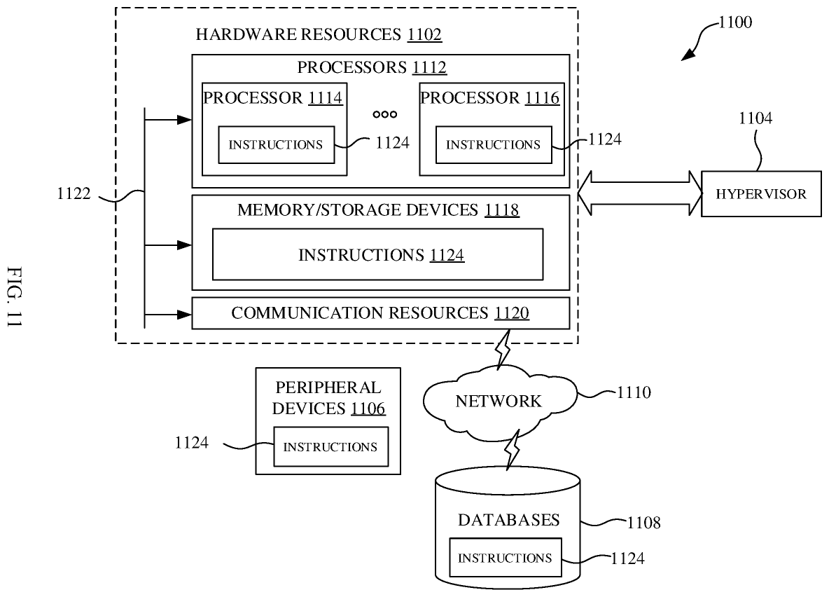

FIG. 10 illustrates example interfaces 1000 of baseband circuitry in accordance with some embodiments. As discussed above, the baseband circuitry 904 of FIG. 9 may include 3G baseband processor 906, 4G baseband processor 908, 5G baseband processor 910, other baseband processor(s) 912, CPU 914, and a memory 918 utilized by said processors. As illustrated, each of the processors may include a respective memory interface 1002 to send/receive data to/from the memory 918.

The baseband circuitry 904 may further include one or more interfaces to communicatively couple to other circuitries/devices, such as a memory interface 1004 (e.g., an interface to send/receive data to/from memory external to the baseband circuitry 904), an application circuitry interface 1006 (e.g., an interface to send/receive data to/from the application circuitry 902 of FIG. 9), an RF circuitry interface 1008 (e.g., an interface to send/receive data to/from RF circuitry 920 of FIG. 9), a wireless hardware connectivity interface 1010 (e.g., an interface to send/receive data to/from Near Field Communication (NFC) components, Bluetooth® components (e.g., Bluetooth® Low Energy), Wi-Fi® components, and other communication components), and a power management interface 1012 (e.g., an interface to send/receive power or control signals to/from the PMC 934.

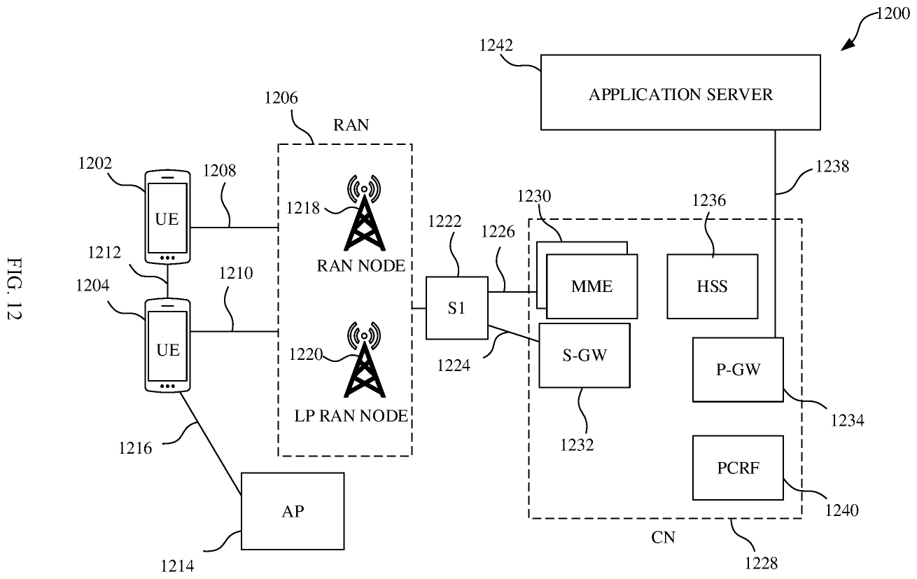

FIG. 11 is a block diagram illustrating components 1100, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1102 including one or more processors 1112 (or processor cores), one or more memory/storage devices 1118, and one or more communication resources 1120, each of which may be communicatively coupled via a bus 1122. For embodiments where node virtualization (e.g., NFV) is utilized, a hypervisor 1104 may be executed to provide an execution environment for one or more network slices/sub-slices to utilize the hardware resources 1102.

The processors 1112 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1114 and a processor 1116.

The memory/storage devices 1118 may include main memory, disk storage, or any suitable combination thereof. The memory/storage devices 1118 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1120 may include interconnection or network interface components or other suitable devices to communicate with one or more peripheral devices 1106 or one or more databases 1108 via a network 1110. For example, the communication resources 1120 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1124 may include software, a program, an application, an applet, an app, or other executable code for causing at least any of the processors 1112 to perform any one or more of the methodologies discussed herein. The instructions 1124 may reside, completely or partially, within at least one of the processors 1112 (e.g., within the processor's cache memory), the memory/storage devices 1118, or any suitable combination thereof. Furthermore, any portion of the instructions 1124 may be transferred to the hardware resources 1102 from any combination of the peripheral devices 1106 or the databases 1108. Accordingly, the memory of the processors 1112, the memory/storage devices 1118, the peripheral devices 1106, and the databases 1108 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

FIG. 12 illustrates an architecture of a system 1200 of a network in accordance with some embodiments. The system 1200 includes one or more user equipment (UE), shown in this example as a UE 1202 and a UE 1204. The UE 1202 and the UE 1204 are illustrated as smartphones (e.g., handheld touchscreen mobile computing devices connectable to one or more cellular networks), but may also include any mobile or non-mobile computing device, such as Personal Data Assistants (PDAs), pagers, laptop computers, desktop computers, wireless handsets, or any computing device including a wireless communications interface.

In some embodiments, any of the UE 1202 and the UE 1204 can include an Internet of Things (IoT) UE, which can include a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 1202 and the UE 1204 may be configured to connect, e.g., communicatively couple, with a radio access network (RAN), shown as RAN 1206. The RAN 1206 may be, for example, an Evolved Universal Mobile Telecommunications System (E-UMTS) Terrestrial Radio Access Network (E-UTRAN), a NextGen RAN (NG RAN), or some other type of RAN. The UE 1202 and the UE 1204 utilize connection 1208 and connection 1210, respectively, each of which includes a physical communications interface or layer (discussed in further detail below); in this example, the connection 1208 and the connection 1210 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UE 1202 and the UE 1204 may further directly exchange communication data via a ProSe interface 1212. The ProSe interface 1212 may alternatively be referred to as a sidelink interface including one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1204 is shown to be configured to access an access point (AP), shown as AP 1214, via connection 1216. The connection 1216 can include a local wireless connection, such as a connection consistent with any IEEE 802.11 protocol, wherein the AP 1214 would include a wireless fidelity (WiFi®) router. In this example, the AP 1214 may be connected to the Internet without connecting to the core network of the wireless system (described in further detail below).

The RAN 1206 can include one or more access nodes that enable the connection 1208 and the connection 1210. These access nodes (ANs) can be referred to as base stations (BSs), NodeBs, evolved NodeBs (eNBs), next Generation NodeBs (gNB), RAN nodes, and so forth, and can include ground stations (e.g., terrestrial access points) or satellite stations providing coverage within a geographic area (e.g., a cell). The RAN 1206 may include one or more RAN nodes for providing macrocells, e.g., macro RAN node 1218, and one or more RAN nodes for providing femtocells or picocells (e.g., cells having smaller coverage areas, smaller user capacity, or higher bandwidth compared to macrocells), e.g., a low power (LP) RAN node such as LP RAN node 1220.

Any of the macro RAN node 1218 and the LP RAN node 1220 can terminate the air interface protocol and can be the first point of contact for the UE 1202 and the UE 1204. In some embodiments, any of the macro RAN node 1218 and the LP RAN node 1220 can fulfill various logical functions for the RAN 1206 including, but not limited to, radio network controller (RNC) functions such as radio bearer management, uplink and downlink dynamic radio resource management and data packet scheduling, and mobility management.

In accordance with some embodiments, the UE 1202 and the UE 1204 can be configured to communicate using Orthogonal Frequency-Division Multiplexing (OFDM) communication signals with each other or with any of the macro RAN node 1218 and the LP RAN node 1220 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can include a plurality of orthogonal sub carriers.

In some embodiments, a downlink resource grid can be used for downlink transmissions from any of the macro RAN node 1218 and the LP RAN node 1220 to the UE 1202 and the UE 1204, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid includes a number of resource blocks, which describe the mapping of certain physical channels to resource elements. Each resource block includes a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1202 and the UE 1204. The physical downlink control channel (PDCCH) may carry information about the transport format and resource allocations related to the PDSCH channel, among other things. It may also inform the UE 1202 and the UE 1204 about the transport format, resource allocation, and H-ARQ (Hybrid Automatic Repeat Request) information related to the uplink shared channel. Typically, downlink scheduling (assigning control and shared channel resource blocks to the UE 1204 within a cell) may be performed at any of the macro RAN node 1218 and the LP RAN node 1220 based on channel quality information fed back from any of the UE 1202 and UE 1204. The downlink resource assignment information may be sent on the PDCCH used for (e.g., assigned to) each of the UE 1202 and the UE 1204.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1206 is communicatively coupled to a core network (CN), shown as CN 1228, via an S1 interface 1222. In embodiments, the CN 1228 may be an evolved packet core (EPC) network, a NextGen Packet Core (NPC) network, or some other type of CN. In this embodiment the S1 interface 1222 is split into two parts: the S1-U interface 1224, which carries traffic data between the macro RAN node 1218 and the LP RAN node 1220 and a serving gateway (S-GW), shown as S-GW 1232, and an S1-mobility management entity (MME) interface, shown as S1-MME interface 1226, which is a signaling interface between the macro RAN node 1218 and LP RAN node 1220 and the MME(s) 1230.

In this embodiment, the CN 1228 includes the MME(s) 1230, the S-GW 1232, a Packet Data Network (PDN) Gateway (P-GW) (shown as P-GW 1234), and a home subscriber server (HSS) (shown as HSS 1236). The MME(s) 1230 may be similar in function to the control plane of legacy Serving General Packet Radio Service (GPRS) Support Nodes (SGSN). The MME(s) 1230 may manage mobility aspects in access such as gateway selection and tracking area list management. The HSS 1236 may include a database for network users, including subscription-related information to support the network entities' handling of communication sessions. The CN 1228 may include one or several HSS 1236, depending on the number of mobile subscribers, on the capacity of the equipment, on the organization of the network, etc. For example, the HSS 1236 can provide support for routing/roaming, authentication, authorization, naming/addressing resolution, location dependencies, etc.

The S-GW 1232 may terminate the S1 interface 1222 towards the RAN 1206, and routes data packets between the RAN 1206 and the CN 1228. In addition, the S-GW 1232 may be a local mobility anchor point for inter-RAN node handovers and also may provide an anchor for inter-3GPP mobility. Other responsibilities may include lawful intercept, charging, and some policy enforcement.

The P-GW 1234 may terminate an SGi interface toward a PDN. The P-GW 1234 may route data packets between the CN 1228 (e.g., an EPC network) and external networks such as a network including the application server 1242 (alternatively referred to as application function (AF)) via an Internet Protocol (IP) interface (shown as IP communications interface 1238). Generally, an application server 1242 may be an element offering applications that use IP bearer resources with the core network (e.g., UMTS Packet Services (PS) domain, LTE PS data services, etc.). In this embodiment, the P-GW 1234 is shown to be communicatively coupled to an application server 1242 via an IP communications interface 1238. The application server 1242 can also be configured to support one or more communication services (e.g., Voice-over-Internet Protocol (VOIP) sessions, PTT sessions, group communication sessions, social networking services, etc.) for the UE 1202 and the UE 1204 via the CN 1228.

The P-GW 1234 may further be a node for policy enforcement and charging data collection. A Policy and Charging Enforcement Function (PCRF) (shown as PCRF 1240) is the policy and charging control element of the CN 1228. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1240 may be communicatively coupled to the application server 1242 via the P-GW 1234. The application server 1242 may signal the PCRF 1240 to indicate a new service flow and select the appropriate Quality of Service (QOS) and charging parameters. The PCRF 1240 may provision this rule into a Policy and Charging Enforcement Function (PCEF) (not shown) with the appropriate traffic flow template (TFT) and QoS class of identifier (QCI), which commences the QoS and charging as specified by the application server 1242.

### ADDITIONAL EXAMPLES

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is a method for a user equipment (UE), comprising: performing positioning to obtain location information of the UE, wherein the location information of the UE indicates location, moving speed and moving direction of the UE; obtaining, from a serving cell, location information of a serving base station and location information of at least one neighbor base station; calculating a propagation time difference between (i) propagation time between the UE and the serving cell and (ii) propagation time between the UE and one or more target neighbor cells of the at least one neighbor base station based on the location information of the UE, the location information of the serving base station and the location information of the at least one neighbor base station; determining a measurement gap configuration for the one or more target neighbor cell based on the propagation time difference and a configured measurement gap for the serving cell; and reporting the measurement gap configuration to the serving base station.

Example 2 is the method of Example 1, wherein the measurement gap configuration comprises an offset applied to the configured measurement gap relative to a timing of the serving cell, wherein the offset is not greater than an offset threshold.

Example 3 is the method of Example 2, wherein the offset threshold is equal to the propagation time difference.

Example 4 is the method of Example 2 or 3, wherein the offset is selected from a group consisting of −2 milliseconds (ms), −1.5 ms, −1 ms, −0.5 ms, 0 ms, 0.5 ms, 1 ms, 1.5 ms, and 2 ms.

Example 5 is the method of Example 1, wherein the measurement gap configuration comprises an extension applied to the configured measurement gap relative to a timing of the serving cell, wherein the extension is not greater than an extension threshold.

Example 6 is the method of Example 5, wherein the extension threshold is equal to the propagation time difference.

Example 7 is the method of Example 5 or 6, wherein the extension is selected from a group consisting of 0 ms, 0.5 ms, 1 ms, 1.5 ms, and 2 ms.

Example 8 is the method of any of Examples 1 to 7, wherein the one or more target neighbor cells are included in a neighbor cell list provided by the serving cell.

Example 9 is the method of any of Examples 1 to 8, wherein the location information of the at least one neighbor base station is indicated by the serving cell using dedicated signaling.

Example 10 is the method of any of Examples 1 to 9, wherein the determining and reporting of the measurement gap configuration is periodic or event triggered.

Example 11 is the method of any of Examples 1 to 10, wherein the at least one neighbor base station and the serving base station are air-to-ground (ATG) base stations and the UE is an ATG UE.

Example 12 is the method of any of Examples 1 to 11, the apparatus comprising one or more processors configured to perform steps of the method according to any of claims 1-11.

Example 13 is a method for a serving base station, comprising: obtaining, from a user equipment (UE), a UE location report or a system frame number (SFN) and frame timing difference (SFTD) report; and determining a measurement gap configuration for one or more target neighbor cells of at least one neighbor base station based, in part, on the UE location report, or based on the SFTD report.

Example 14 is the method of Example 13, further comprising obtaining location information of the at least one neighbor base station from the at least one neighbor base station or from a location server, wherein the UE location report comprises location, moving speed and moving direction of the UE, and wherein the measurement gap configuration is determined based on the location, moving speed and moving direction of the UE, location information of the serving base station, and the location information of the at least one neighbor base station.

Example 15 is the method of Example 13, wherein the SFTD report comprises measurements of SFTD between the serving cell and the one or more target neighbor cells.

Example 16 is the method of Example 13, wherein the measurement gap configuration comprises an extended measurement gap length relative to a timing of the serving cell.

Example 17 is the method of Example 16, wherein the extended measurement gap length is selected from a group consisting of: 1.5 ms, 3 ms, 3.5 ms, 4 ms, 5.5 ms, 6 ms, 6.5 ms, 7.0 ms, 7.5 ms, and 8 ms.

Example 18 is the method of Example 13, wherein the measurement gap configuration comprises an offset applied to a configured measurement gap relative to a timing of the serving cell, wherein the offset is not greater than an offset threshold.

Example 19 is the method of Example 18, wherein the offset is selected from a group consisting of: −2 ms, −1.5 ms, −1 ms, −0.5 ms, 0 ms, 0.5 ms, 1 ms, 1.5 ms, and 2 ms.

Example 20 is the method of any of Examples 13 to 20, further comprising configuring the measurement gap configuration to the UE via one of: radio resource control (RRC) signaling, medium access control (MAC) control element (CE) and downlink control information (DCI).

Example 21 is the method of any of Examples 13 to 20, wherein the at least one neighbor base station and the serving base station are air-to-ground (ATG) base stations and the UE is an ATG UE.

Example 22 is an apparatus for a communication device, including means for performing steps of the method according to any of Examples 1-11.

Example 23 is a computer program product includes computer programs which, when executed by one or more processors, cause an apparatus to perform steps of the method according to any of Examples 1-11.

Example 24 is a computer readable medium having computer programs stored thereon which, when executed by one or more processors, cause an apparatus to perform steps of the method according to any of Examples 1-11.

Example 25 is an apparatus for a base station, the apparatus comprising one or more processors configured to perform steps of the method according to any of Examples 13-21.

Example 26 is an apparatus for a base station, including means for performing steps of the method according to any of Examples 13-21.

Example 27 is a computer program product includes computer programs which, when executed by one or more processors, cause an apparatus to perform steps of the method according to any of Examples 13-21.

Example 28 is a computer readable medium having computer programs stored thereon which, when executed by one or more processors, cause an apparatus to perform steps of the method according to any of Examples 13-21.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. are merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-21. (canceled)

22. A method comprising:
performing positioning to obtain location information of a user equipment (UE);
obtaining, from a serving cell, location information of a serving base station and location information of at least one neighbor base station;
calculating a propagation time difference between a propagation time between the UE and the serving cell and a propagation time between the UE and one or more target neighbor cells of the at least one neighbor base station based on the location information of the UE, the location information of the serving base station and the location information of the at least one neighbor base station;
determining a measurement gap configuration for the one or more target neighbor cells based on the propagation time difference and a configured measurement gap for the serving cell; and
reporting the measurement gap configuration to the serving base station.

23. The method of claim 22, wherein the measurement gap configuration comprises an offset applied to the configured measurement gap relative to a timing of the serving cell, wherein the offset is not greater than an offset threshold.

24. The method of claim 23, wherein the offset threshold is equal to the propagation time difference.

25. The method of claim 23, wherein the offset is −2 milliseconds (ms), −1.5 ms, −1 ms, −0.5 ms, 0 ms, 0.5 ms, 1 ms, 1.5 ms, or 2 ms.

26. The method of claim 22, wherein the measurement gap configuration comprises an extension applied to the configured measurement gap relative to a timing of the serving cell, wherein the extension is not greater than an extension threshold.

27. The method of claim 26, wherein the extension threshold is equal to the propagation time difference.

28. The method of claim 26, wherein the extension is 0 milliseconds (ms), 0.5 ms, 1 ms, 1.5 ms, or 2 ms.

29. The method of claim 22, wherein the one or more target neighbor cells are included in a neighbor cell list provided by the serving cell.

30. The method of claim 22, wherein the location information of the at least one neighbor base station is indicated by the serving cell using dedicated signaling.

31. The method of claim 22, wherein the determining and reporting of the measurement gap configuration is periodic or event triggered.

32. The method of claim 22, wherein the at least one neighbor base station and the serving base station are air-to-ground (ATG) base stations and the UE is an ATG UE

33. One or more non-transitory, computer-readable media having instructions that, when executed, cause processor circuitry to:
obtain, from a user equipment (UE), a UE location report or a system frame number (SFN) and frame timing difference (SFTD) report; and
determine a measurement gap configuration for one or more target neighbor cells of at least one neighbor base station based, in part, on the UE location report, or based on the SFTD report.

34. The one or more non-transitory, computer-readable media of claim 33, wherein the instructions, when executed, further cause the processor circuitry to:
obtain location information of the at least one neighbor base station from the at least one neighbor base station or from a location server,
wherein the UE location report comprises a location, moving speed, or moving direction of the UE, and the measurement gap configuration is determined based on: the location, moving speed, or moving direction of the UE; location information of a serving base station; and the location information of the at least one neighbor base station.

35. The one or more non-transitory, computer-readable media of claim 33, wherein the SFTD report comprises measurements of SFTD between a serving cell and the one or more target neighbor cells.

36. The one or more non-transitory, computer-readable media of claim 33, wherein the measurement gap configuration comprises an extended measurement gap length relative to a timing of a serving cell.

37. The one or more non-transitory, computer-readable media of claim 36, wherein the extended measurement gap length is 1.5 milliseconds (ms), 3 ms, 3.5 ms, 4 ms, 5.5 ms, 6 ms, 6.5 ms, 7.0 ms, 7.5 ms, or 8 ms.

38. The one or more non-transitory, computer-readable media of claim 33, wherein the measurement gap configuration comprises an offset applied to a configured measurement gap relative to a timing of a serving cell, wherein the offset is not greater than an offset threshold.

39. The one or more non-transitory, computer-readable media of claim 38, wherein the offset is −2 milliseconds (ms), −1.5 ms, −1 ms, −0.5 ms, 0 ms, 0.5 ms, 1 ms, 1.5 ms, or 2 ms.

40. The one or more non-transitory, computer-readable media of claim 33, wherein the instructions, when executed, further cause the processor circuitry to:
configure the measurement gap configuration to the UE via radio resource control (RRC) signaling, medium access control (MAC) control element (CE), or downlink control information (DCI).

41. The one or more non-transitory, computer-readable media of claim 33, wherein the at least one neighbor base station and the serving base station are air-to-ground (ATG) base stations and the UE is an ATG UE.
